(19) United States
(12) Patent Application Publication
(10) Pub. No.: US 2010/0121509 A1
(43) Pub. Date: May 13, 2010

(54) VEHICLE AND TRAFFIC SYSTEM

(76) Inventors: Nagae Takeshima, Tokyo (JP); Yoshihito Takeshima, Tokyo (JP)

Correspondence Address: OLIFF & BERRIDGE, PLC, P.O. BOX 320850, ALEXANDRIA, VA, 22320-4850, US

(21) Appl. No.: 12/452,004

(22) PCT Filed: Jun. 22, 2008
(86) PCT No.: PCT/JP2008/061367

§ 371 Date: Dec. 11, 2009

(30) Foreign Application Priority Data
Jun. 25, 2007 (JP) 2007-167037

(51) Int. Cl. G06F 7/00; E01C 1/00

(52) U.S. Cl. 701/22; 404/1

(57) ABSTRACT

Provided are a vehicle having high degree of operation freedom due to electric power being able to be supplied to the vehicle during its travel and due to the vehicle being able to drive on normal roads, and a traffic system. A large number of overhead lines are arranged over a road. An extendable electric power collector is provided at the rear of the vehicle, and a battery and a drive mechanism are mounted on the vehicle. When the power collector is in contact with an overhead line, electric power supplied from the overhead line is supplied to the battery to charge it and electric power is supplied also to the drive mechanism. When the vehicle travel on a normal road having no such overhead lines, electric power is supplied from the battery to the drive mechanism.

### TECHNICAL FIELD

The present invention relates to a traffic system which utilizes electricity as a power for transportation purpose. More particularly, the invention is directed to an improvement of the traffic system of this kind intended for a vehicle(s) having buttery provided therein, which is designed to allow the vehicle to be electrically propelled for travel on roads through electric power stored in the buttery.

### BACKGROUND ART

There has been known a traffic system that allows vehicle to be electrically propelled for travel on roads through electric power stored in a buttery provided in the vehicle and also allows for supply of electric power form overhead lines to the vehicle. Examples of such vehicle and traffic system include the under-listed patent prior-art materials, namely, the patent literature Nos. 1 to 4. All those prior arts commonly disclose a traffic system wherein overhead lines are arranged in a particular zone, such that electric power may be supplied from the overhead lines to each of vehicles to charge a battery of the corresponding vehicle, and wherein, when in an area having no such overhead line, the vehicle can be driven electrically by the electric power stored in the battery to travel on roads.

Patent Literature No. 1: Japanese Laid-Open Patent Publication No. 2007-60854

Patent Literature No. 2: Japanese Laid-Open Patent Publication No. 2002-238017

Patent Literature No. 3: Japanese Laid-Open Patent Publication No. 2002-281610

Patent Literature No. 4: Japanese Laid-Open Patent Publication No. 2002-165311

### DISCLOSURE OF THE INVENTION

### Problems to be Solved by the Present Invention

However, the aforementioned prior arts are all designed for use with public transportation facilities, such as electric tramway and trolley bus, and not intended for any private transportation means, such as a private automobile, which has a high degree of freedom for its operation and travel in comparison with the public transportation facilities.

With the foregoing drawback in view, it is a purpose of the present invention to provide a vehicle as well as a traffic system which allows electric power to be supplied to the vehicle which is in the state of traveling on road, and also provides a high degree of operation freedom for the vehicle, such that there is no need for provision of track and rail to guide the vehicle, thereby allowing for unrestrained travel of the vehicle on any normal road.

### Means for Solving the Problems

In order to achieve the above-stated purpose, in accordance with the present invention, there is provided a vehicle to be occupied and driven by person(s) for travel on road, which is characterized by comprising: an electric power collector adapted for receiving and collecting an electric power supplied from overhead line(s) arranged above the road; a lifting device operable for vertical movement with respect to the overhead line(s) to which the electric power collector is made accessible; a battery capable of storing the electric power therein; a drive mechanism for causing movement of the vehicle; a power supply/distribution control unit which, responsive to the electric power being supplied from the electric power collector, operates to cause the electric power to supply to one or both of the battery and drive mechanism, or alternatively operates to cause the electric power stored in the battery to supply to the drive mechanism, responsive to no electric power supplied from the electric power collector; and a steering wheel sensor for detecting movement of a steering wheel of the vehicle, the steering wheel sensor being workable such that, upon detecting rotation of the steering wheel by an angle exceeding a predetermined angle, the steering wheel sensor outputs one signal for prohibiting contact of said electric power collector with the overhead line(s) and sends such one signal to said lifting device, and that, upon said steering wheel having been rotated reversely from the thus-rotated state back to a normal home position, the steering wheel sensor outputs another signal calling for contact of the electric power collector with the overhead line(s) and sends such another signal to the lifting device.

Another aspect of the above-described vehicle of the present invention is characterized by including an overhead line detection sensor for detecting presence and absence of the overhead line(s), the overhead line detection sensor being workable such that, upon detecting the overhead line(s), the overhead line detection sensor outputs one signal calling for contact of the electric power collector with the overhead line(s) and sends such one signal to the lifting device, and that, upon detecting no overhead line, the overhead line detection sensor outputs another signal for prohibiting contact of the electric power collector with the overhead line(s) and sends such another signal to the lifting device.

Still another aspect of the above-described vehicle of the present invention is characterized by including a lifting control means workable in such a manner that, while the overhead line(s) is/are being detected by the overhead line detection sensor, if the steering wheel sensor detects rotation of the steering wheel by an angle exceeding a predetermined angle, the lifting control means outputs one signal for prohibiting contact of the electric power collector with the overhead line(s) and sends such one signal to the lifting device, and that, upon the steering wheel having been rotated reversely from the thus-rotated state back to a normal home position, the lifting control means outputs another signal calling for contact of the electric power collector with the overhead line(s) and sends such another signal to the lifting device, wherein the lifting control means is also workable such that, if no overhead line is detected by the overhead line detection sensor, the lifting control means positively works to prohibit contact of the electric power collector with the overhead line(s), irrespective of any detection result received from the steering wheel sensor.

As one of principal embodiments applicable to the present invention, the vehicle is characterized by comprising: a charging plug for allowing the battery to be charged in the midst of the vehicle being parked; and a rectifier for rectifying an electric power supplied from the charging plug, and also characterized in that, upon the electric power being supplied to the charging plug, the power supply/distribution control unit works to cause electric power outputted from the rectifier to supply to the battery, thereby charging that particular battery. As another embodiment applicable to the invention, the vehicle is characterized in that the electric power collector includes a ringed portion defined therein, the ringed portion being adapted for contact with the overhead line(s).

In the present invention, a traffic system is provided for use with any one of the above-described vehicles, the traffic system being characterized in that a road is provided, which has a plurality of lanes defined therein, and the afore-said overhead line(s) is/are arranged in each of such plurality of lanes. As one aspect of the present invention, the traffic system for use with any one of the above-described vehicles is characterized in that a road is provided, which has a plurality of lanes defined therein, and the overhead line(s) is/are arranged in at least one of such plurality of lanes. As one of principal embodiments applicable to the invention, the traffic system for use with the above-described vehicles is characterized in that a road is provided, which has a plurality of lanes defined therein, and at least one of such plurality of lanes includes a means for allowing the battery to be charged, while said vehicle is traveling on that at least one of the plurality of lanes. In addition, according to another embodiment applicable to the invention, the traffic system is characterized in that an obstacle element is provided, which prevents entry of people into the road having overhead line(s) arranged therein, such that the obstacle element is disposed along a boundary between the road and other areas than the road. It is to be noted that other purposes, features and advantages of the present invention as well as the above-described purposes, features and advantages will become apparent more specifically by reading of the detailed description, hereinafter, with reference to the annexed drawings.

### Effects of the Present Invention

In accordance with the present invention, the overhead line(s) is/are utilized, which allows supply of electric power therefrom to vehicle(s) being in the state of traveling on road(s), and also the battery in the vehicle(s) may be charged from the overhead line(s) so that the vehicle will continue to run on ordinary roads having no such overhead line(s), hence providing a high degree of operation freedom of the vehicles. In addition, the vehicle uses electricity as its energy and therefore provides excellent eco-friendly effects and performances, such as no emission of exhaust and no generation of undesired noise.

### BRIEF DESCRIPTION OF THE DRAWINGS

FIG. 1 provides diagrams showing a principal part of Embodiment 1 of the present invention.

FIG. 2 provides block diagrams for showing the operations of an electric supply/distribution control unit used in the preceding embodiment.

FIG. 3 is a diagram for explanatorily showing how a vehicle used in the preceding embodiment is to move.

FIG. 4 provides plan views showing an Embodiment 2 of the present invention.

FIG. 5 is a diagram for showing an Embodiment 3 of the present invention.

FIG. 6 is a diagram for showing an Embodiment 4 of the present invention.

FIG. 7 illustrates an Embodiment 5 of the present invention.

### DESCRIPTION OF REFERENCE NUMERALS IN THE DRAWINGS

10: Vehicle

12: Electric power collector

14: Lifting device

16: Up-down switch

18: Steering wheel

20: Steering wheel sensor

24: Battery

26: Drive mechanism

28: Power supply/distribution control unit

30: Overhead line

31: Rectifier

32: Charging plug

34: Brush-like ground element

36: Fence

100: Road

100A to 100C: Lanes

102: Center line

200: Road

300: Parking lot

302: Outlet

400: Overhead line

402: Transversal line

410: Overhead line

412: Connecting point

420: Transversal line

500: Vehicle

502: Electric power collector

502A: Ringed contact element

502B: Support rod

504: Overhead line detection sensor

506: Lifting device

600: Vehicle

602: Lifting device control circuit

604: Lifting device

700: Road

702: Electric power supply lane

704,706: Lanes

710,712: Overhead lines

### BEST MODE FOR CARRYING OUT THE PRESENT INVENTION

The present invention may be embodied in many various ways within the scopes of the appended claims, but, hereinafter, several exemplary modes of the invention which are deemed appropriate will now be described in details.

### Embodiment 1

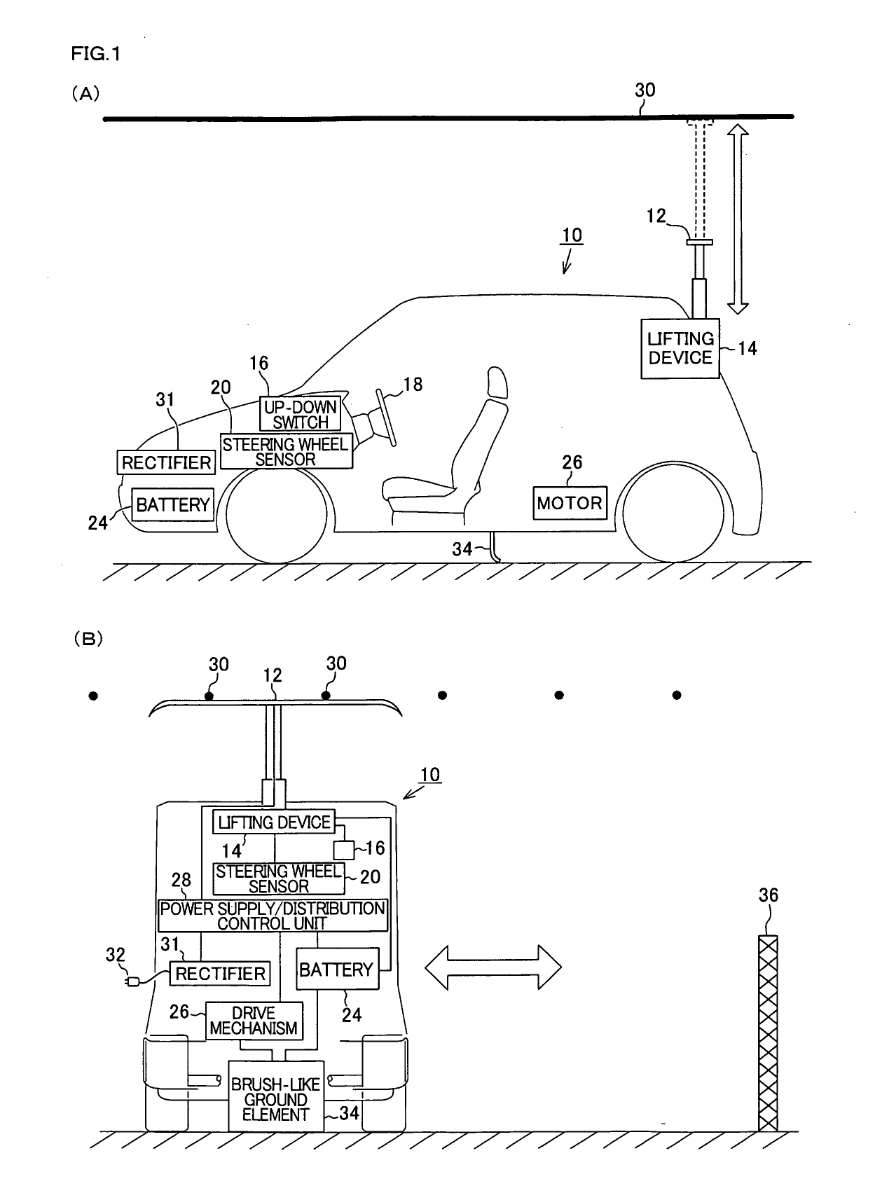

First of all, referring to FIGS. 1 to 3, a description will be made of a 1st embodiment of the present invention. FIG. 1(A) is a diagram illustrative of principal constituent parts arranged in a vehicle 10 as applied to the present embodiment. FIG. 1(B) schematically shows how the vehicle is to be controlled and driven on the road. In those two Figures, it is to be understood that, as similar to ordinary electric vehicle driven by electric motor, the vehicle 10 of the present embodiment is provided with steering wheel, seats, front and rear wheels, a speedometer, an accelerator pedal, a brake pedal, and so forth.

In the illustrative embodiment, an electric power collector 12 is disposed at a point rearwardly and upwardly of the vehicle 10. And also, arranged above the road are a plurality of overhead lines 30 adapted for feeding electric power to vehicles, such that, for example, the overhead lines extend abreast along the road in a 10-cm spaced-apart relation with one another. On the other hand, the electric power collector 12 provided on the vehicle may for example have a width of approx. 20-cm which is enough to retain at least two of the overhead lines 30 in contact with that power collector 12. Owing to this arrangement, if one of the two overhead lines 30 happens to be out of contact with the power collector 12 for some reasons or other, the other of the overhead lines 30 still remains in contact with the power collector to thereby continue supply of electric power to the vehicle. Note that a fence 36 is provided on and along the boundary between both two lateral sides of the road and the adjacent fields in order to prevent invasion of people and animals into the road.

The aforementioned electric power collector 12 is moved upwards and downwards by operation of the lifting device 14. This vertical movement of electric power collector 12 may be controlled by an up-down switch 16 which is manually operable by a driver in the vehicle, or may be controlled through a steering wheel sensor 20 which detects an angle of rotation of a steering wheel 18 and outputs a corresponding detection signal for proper vertical movement of the electric power collector. The steering wheel sensor 20 may for example be composed by a known potentiometer, known encoders and other required elements. Further, in the vehicle 10, a battery 24 is installed, and also a drive mechanism 26 s provided to cause revolution of the wheels of the vehicle. The drive mechanism 26 may include a motor and a transmission mechanism for instance, but, instead thereof, it may simply comprise an in-wheel motor preinstalled in each of wheels of the vehicle, for elimination of the transmission mechanism therefrom.

Electrically connected with a power supply/distribution control unit 28 are: the afore-said electric power collector 12; a power supply terminal of the afore-said drive mechanism 26; and one of electrodes of the afore-said battery 24. On the other hand, another remaining electrode(s) of the battery 24 as well as another remaining terminal(s) of the drive mechanism 26 are electrically connected with a brush-like ground element 34. The power supply/distribution control unit 28 further includes a charging plug 32 connected electrically therewith via a rectifier 31. The charging plug 32 may for example be of what is known as “plug-in” type connectable to a commercially based alternating-current outlet found in a parking lot or garage, for the purpose of charging the battery 24. While not shown, it is to be noted that an electric power in the battery 24 will also be supplied to each of other electric elements and mechanisms provided in the vehicle 10 to thereby enable those other elements and mechanisms to effect their required operations.

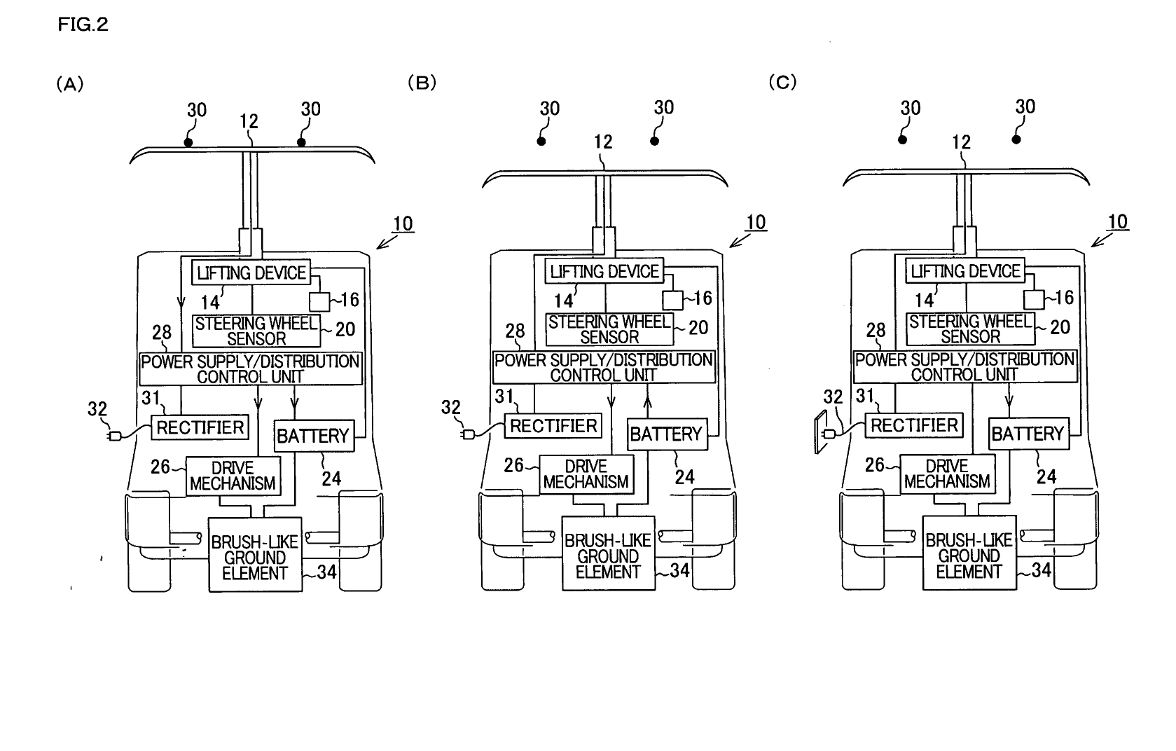

Referring now to FIG. 2, a description will be made of a basic operation of the power supply/distribution control unit 28. In brief, the power supply/distribution control unit 28 operates to detect voltages respectively associated with the electric power collector 12 and charging plug 32, and execute a proper control processing, depending on the degree of the thus-detected voltages, to effect one of the controls shown in FIGS. 2(A) to 2(C). Specifically, as a first example, suppose that the electric power collector 12 is brought to contact with the overhead lines 30, and responsive thereto, a predetermined voltage is detected by the power supply/distribution control unit 28. In that case, as shown in FIG. 2(A), the power supply/distribution control unit 28 operates to cause an electric power supplied from the overhead lines 30 to flow to the battery 24, thereby charging that battery, while at the same time causing the electric power to supply to the drive mechanism 26 as well. On the contrary, when detecting no voltage from the electric power collector 12 and no voltage from the charging plug 32, neither, the power supply/distribution control unit 28 operates to cause an electric power in the battery 24 to supply to the drive mechanism 26, as shown in FIG. 2(B). As still another example, when detecting a predetermined voltage from the charging plug 32, the power supply/distribution control unit 28 operates to cause electric power supplied from the rectifier 31 to flow to the battery 24, thereby charging that battery, as shown in FIG. 2(C). Those all operations of power supply/distribution control unit 28 may be controlled by a sequencer, or may be programmed by a computer for computerized control purpose.

Now, operations of the steering wheel sensor 20 will be described. Steering wheel sensor 20 is designed to detect an angle of rotation of the steering wheel 18 provided in the vehicle 10 and arranged such that, if the steering wheel 18 is rotated by an angle that exceeds a predetermined angle of rotation, a detection signal indicative of such excessive rotation is outputted from the sensor 20 and sent to the lifting device 14. Hence, upon receipt of such detection signal, the lifting device 14 is operated to cause downward movement of the electric power collector 12 away from the overhead lines 30 with which that electric power collector has been contacted. On the other hand, when the steering wheel 18 is reversely rotated from the thus-rotated state to a normal home position, the steering wheel sensor 20 detects such reverse rotation of steering wheel and outputs a corresponding detection signal to the lifting device 14. Upon receipt of such detection signal, the lifting device 14 is operated reversely, with the result that the electric power collector 12, which has been lowered away from the overhead lines 30, is now moved by the lifting device upwardly and brought to contact with the overhead lines 30. It is therefore to be appreciated that, every time the vehicle 10 turns to the left or the right, or changes the lane to another lane, the electric power collector 12 is automatically lowered away from the overhead lines, and thereafter, upon the vehicle 10 moving again in a straight line, the electric power collector 12 is automatically raised and brought to contact with the overhead lines 30.

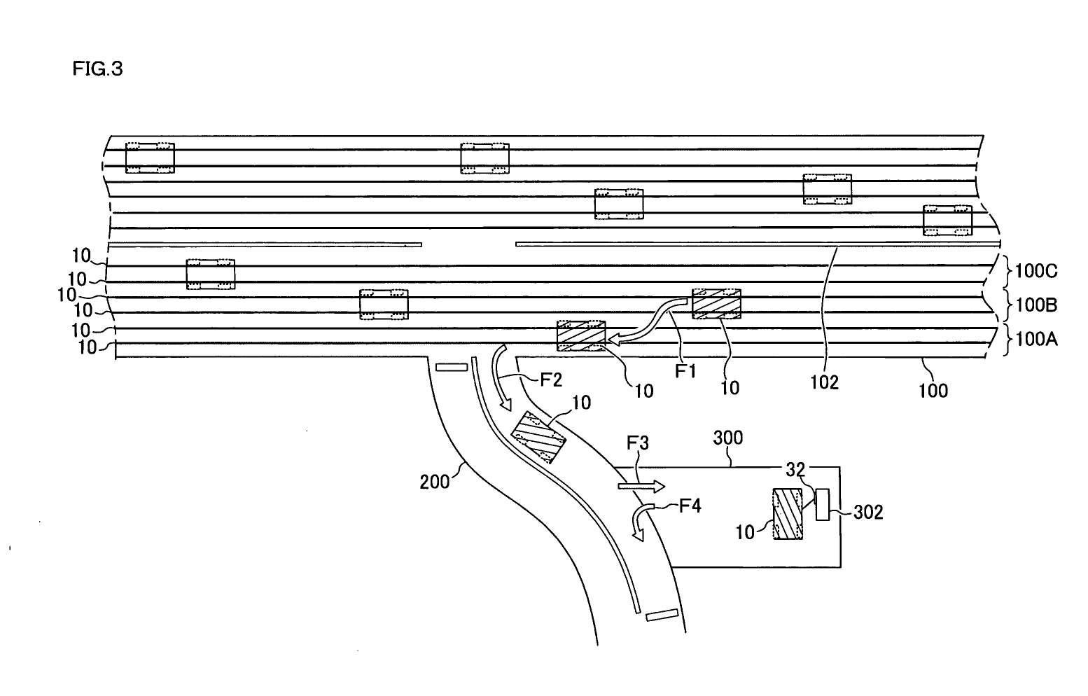

Referring now to FIG. 3, let us assume that the vehicle 10 travels in the shown manner, by way of one example in the present embodiment. Based on such illustration, a whole of operations and actions of the present embodiment will be described hereinafter. In the FIG. 3, a six-lane road 100 is illustrated, with six overhead lines 30 arranged above and along each of the there-lane section of that particular road. More specifically, arranged above and along each of the three lanes 100A to 100C are a pair of overhead lines 30 in a parallel relation with each other. According to the shown embodiment, it is observed that the vehicle 10 to be discussed hereinafter travels on the central lane 100B. It should be understood here that the electric power collector 12 has been raised by driver's manual operation of the up-down switch 16 and is now in contact with the two overhead lines 30, and that a brush-like ground element 34 is set in contact with the surface of the road. Thus, as shown in FIG. 2(A), an electric power is supplied from the two overhead lines 30 to both of the battery 24 and drive mechanism 26 through the electric power collector 12. With such supply of electric power, the battery 24 is charged, while the drive mechanism 26 is simultaneously operated for revolution of wheels of the vehicle, so that the vehicle 10 travels on the road, as shown.

Next, as indicated by the arrow F1 in the FIG. 3, suppose that the driver turns the steering wheel 18 so as to displace the vehicle from the central lane 100B to another lane 100C. Such rotation of steering wheel is detected by the steering wheel sensor 20 which in turns outputs and sends a corresponding detection signal to the lifting device 14. Upon receipt of that signal, the lifting device 14 is operated to lower the electric power collector 12 away from the two overhead lines 30, thereby permitting the vehicle 10 to change the lane as stated above, with the electric power collector 12 being out of contact with the two overhead lines 30. During this change of direction of vehicle, an electric power is still being supplied from the battery 24 to the drive mechanism 26, thanks to the control previously described with reference to FIG. 2(B), thereby insuring continued operation of the drive mechanism 26. Hence, the vehicle 10 can continue traveling on the road, without any stoppage and without any trouble incidental thereto. After completion of such change of lane, upon the steering wheel 18 having been turned by the driver to a normal home position for straight-ahead driving, the steering wheel sensor 20 detects such rotation of the steering wheel. Then, responsive to that detection, the lifting device 14 is operated to raise the electric power collector 12 towards another pair of overhead lines. Thus, in the same manner as previously stated with reference to FIG. 2(A), an electric power is supplied from those overhead lines 30, via the electric power collector 12, to both of the battery 24 and drive mechanism 26, thereby charging the battery 24 and also causing simultaneous operation of the drive mechanism 16, so that the vehicle 10 travels on the corresponding lane.

On the other hand, as indicted by the arrow F2 in the FIG. 3, suppose that the vehicle 10 turns to the left and enters another road 200. A description will be made of such instance, hereinafter. Briefly stated, the driver actually turns the steering wheel 18 in this case also, which therefore results in the electric power collector 12 being automatically lowered away from the overhead line in accordance with the controls and operations described earlier. But, in the present case, no overhead line 30 is provided above the road 200, and therefore, the driver has to operate the up-down switch 16 so as to cause the electric power collector 12 to move downwards and reach a storage position. Under such state, the vehicle 10 continues traveling on the road 200, due to an electric power being still supplied from the battery 24 to the drive mechanism 26 under the controls and operations previously described with reference to FIG. 2(B).

Reference being now made to the indication of arrow F3 in the FIG. 3, suppose that the vehicle 10 goes into the parking lot 300 and is parked there, and that the charging plug 32 is connected to an outlet 302. In that case, the supply of electric power is controlled as shown in FIG. 2(C). Namely, an alternating-current electric power supplied from the charging plug 32 is changed by the rectifier 31 into a direct-current electric power which is in turn supplied to the battery 24, thereby charging that battery 24. It is noted here that, if the parking lot 300 has overhead lines provided therewith, a driver may wish to cause the electric power collector 12 to raise and bring to contact with the overhead lines for the purpose of charging the battery 24. After completion of charging the battery, upon disengagement of the charging plug 32 from the outlet 302 to start the vehicle, the distribution and supply of electric power is executed as illustrated in FIG. 2(B), thereby allowing electric power to be supplied from the battery 24 to the drive mechanism 26. Hence, the driver can move the vehicle 10 back to the road 200, as indicated by the arrow F4 in FIG. 3, so that the vehicle 10 will travel on that road 200.

From the description above, in accordance with the present embodiment, it is to be appreciated that the following advantageous effects are attainable:
(1) When the vehicle travels on a road having the overhead lines 30, it is possible to maintain supply of electric power from the overhead lines for continued operation of the drive mechanism 20, thereby providing for continued travel of the vehicle on the road.
(2) Charging the battery 24 can be effected anytime during travel of the vehicle on a road having overhead lines 30 and also effected when the vehicle is parked in a parking lot, which therefore makes it possible to reduce the capacity and size of the battery 24 to be installed in the vehicle.
(3) Due to an electric power being supplied from the charged battery 24, it is possible to continue travel of the vehicle on a road having no overhead line.
(4) Every time the vehicle turns to the left or the right, or changes the lane, the rotation of the steering wheel 18 is detected, and responsive thereto, a proper control is executed to automatically cause vertical movement of the electric power collector 12. Thus, it is smooth and quick for a driver to bring that electric power collector 12 to contact with the overhead lines 30, or lower the former out of contact with the latter.
(5) The vehicle per se is electrically propelled for travel on road and therefore provided with various eco-friendly effects and performances, such as no emission of exhaust gas and no generation of undesired noise, which is superior to vehicles requiring gasoline as its fuel.

As described above, the electric power collector 12 may be raised and lowered automatically responsive to the steering wheel being rotated to either the left or the right, or alternatively, a driver may operate the up-down switch 16 to cause lowering of the electric power collector 12 to a storage position in the case of no need for contact of that power collector with the overhead lines. But, there may be provided a means for automatically lowering the electric power collector 12 to a storage position, with such an arrangement that, if no electric power is supplied to the electric power collector 12 raised and contacted with the overhead lines and after lapse of a predetermined time during such no supply of electric power, the electric power collector 12 is automatically lowered to the storage position. Such automated arrangement and operation will effectively work in the case where the vehicle travels on a road having no overhead line arranged thereabove, or in the case where the vehicle moves in a parking lot or the like which has no overhead line provided therewith.

### Embodiment 2

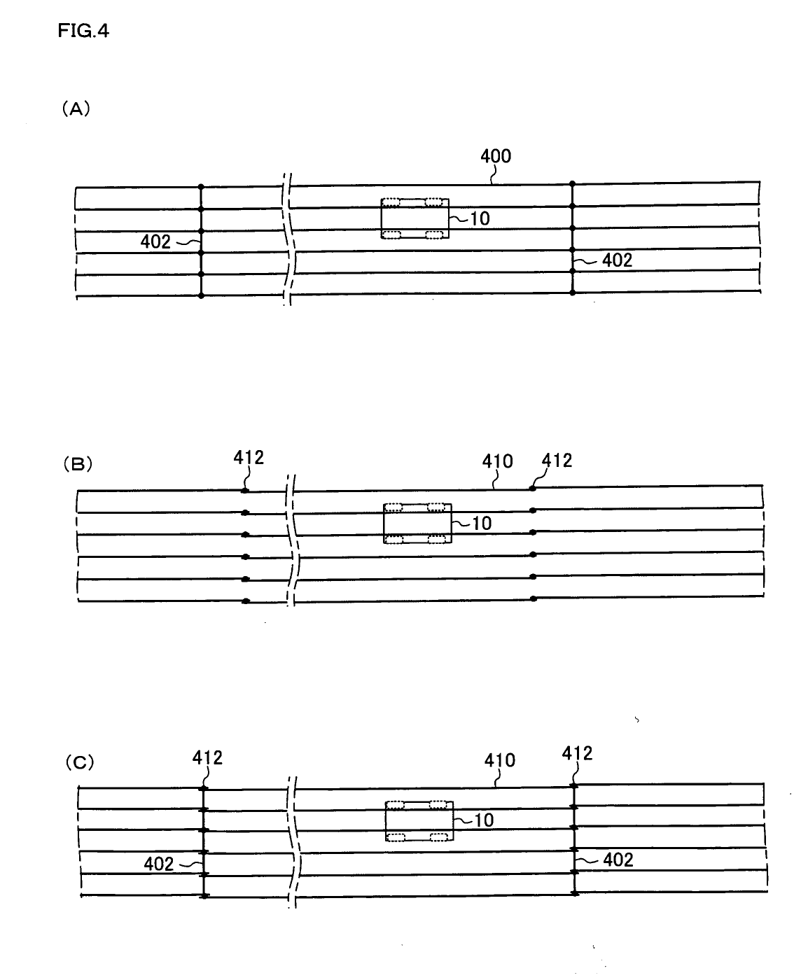

With reference to the illustrations shown in FIG. 4, the 2nd embodiment of the present invention will now be described, hereinafter. FIG. 4(A) shows one variant of the present embodiment wherein a plurality of overhead lines 400 are shown and transversal lines 402 are electrically connected with those overhead lines 400, whereby all the overhead lines 400 are in an electrically connected relation with one another. Namely, each of the transversal lines 402 extends transversely of all the overhead lines 400 and has an electrical connection with each of the all overhead lines 400 and, with that arrangement, even if many vehicles running on the road happen to intensively cause their all electric power collectors to contact one overhead line 400 or one particular pair of the overhead lines 400, an electric power is then supplied from other remaining overhead lines 400, via the transversal lines 402, to the overhead line(s) 400 in question with which many vehicles are now connecting their electric power collectors intensively, thereby preventing undesired decrease of voltage, so that all the vehicles can smoothly travel on the road. FIG. 4(B) shows another variant of the present embodiment wherein overhead lines 410 are shown as being electrically connected with each other by means of connecting points 412. This arrangement permits use of a plurality of short electrically conductive lines as overhead lines 410, so that a plurality of overhead lines 410 are electrically connected with one another, which advantageously allows for easy replacement of the lines with another new lines. FIG. 4(C) shows still another variant of the present embodiment wherein the aforementioned two variants of FIGS. 4(A) and 4(B) are combined together to provide a further improved mode. Namely, short overhead lines 410 are electrically connected with each other by the connecting points 412 which are in turn electrically connected together by the transversal line 420, thereby electrically connecting the shown large number of overhead lines 410 with one another. Accordingly, it is possible to simultaneously execute both of the following two works: a work for connecting the overhead lines 410 with each other; and a work for coupling the transversal lines 420 with the overhead lines 410, thus attaining a highly efficient wiring workability.

### Embodiment 3

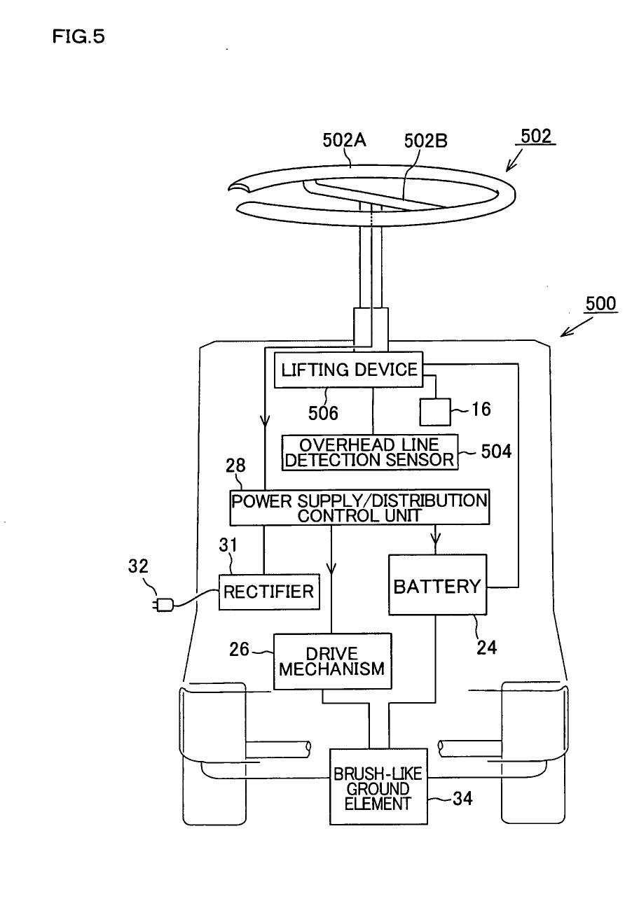

Referring to FIG. 5, a 3rd embodiment of the present invention will be described, hereinafter. In the FIG. 5, there is illustrated a vehicle 500 basically similar in structure to the vehicle described previously, except that it has an electric power collector 502 which comprises a ringed contact element 502A and a generally T-shaped support rod 502B, such that the ringed contact element 502A is supportively connected with the lifting device 506 by that support rod 502B. The ringed formation of contact element 502A has the advantage that, irrespective of any direction in which the vehicle 500 may move towards the overhead lines, the ringed contact element 502A is positively brought in a sufficient contact with the overhead lines. Further, according to the present embodiment, an overhead line detection sensor 504 is shown as being electrically connected with the lifting device 506. The overhead line detection sensor 504 is adapted for detecting the presence and absence of overhead lines above the vehicle 500. An example of sensor usable for constituting such overhead line detection sensor 504 include a known electric field sensor or a known proximity switch. For instance, this overhead line detection sensor 504 may be provided on the afore-said electric power collector 502. However, instead of the overhead line detection sensor 504, a signal device may be arranged in an area where the overhead lines are provided, in such a manner that the signal device outputs a signal (such as wireless signal, optical signal or ultrasonic signal) indicative of the presence of overhead lines, and, upon such signal outputted from the signal device having been received by a receiver provided in the vehicle, a driver may notice and ascertain the presence or absence of overhead lines from the receiver.

From the present embodiment thus described, it is to be appreciated that, according to a result of detection of the overhead line detection sensor 504, the electric power collector 502 is automatically moved in the vertical direction through operation of the lifting device 506. In addition, the electric power collector 502, by the reason of its ringed configuration, is positively brought in a satisfied contact with the overhead lines, regardless of any direction from which that electric power collector 502 may be brought to the overhead lines. In this context, the manually operable up-down switch 16 in the preceding embodiment may be incorporated in the automatically controlled present embodiment, such that, when the up-down switch 16 is turned to an “UP” position for causing upward movement of the electric power collector, the electric power collector is automatically raised or lowered, depending on a result of detection of the afore-said overhead line detection sensor 504.

### Embodiment 4

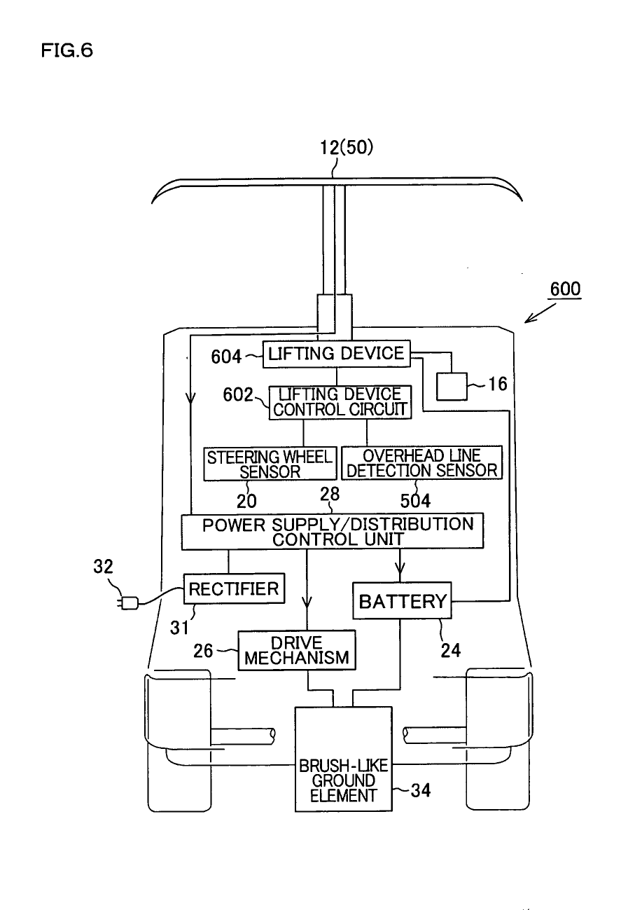

Reference being now to FIG. 6, a description will be made of a 4th embodiment of the present invention. In this embodiment, there is shown a vehicle 600 wherein a lifting device control circuit 602 is provided, by way of which, the previously stated steering wheel sensor 20 and overhead line detection sensor 504 are electrically connected with a lifting device 604, so that, in accordance with signals outputted from those two sensors, the vertical movement of the electric power collector 12 (or 502) is controlled automatically through the lifting device control circuit.

The lifting device control circuit 602 has function for causing the under-described controls as to the vertical movement of electric power collector.
(1) Suppose that overhead lines are detected by the overhead line detection sensor 504. In that case, the lifting device control circuit 602, upon receiving a detection signal from the steering wheel sensor 20 and depending on the kind of such signal, will electrically function so as to properly control the vertical movement of electric power collector 12. Briefly stated, under the control of the lifting device control circuit, if the steering wheel 18 is rotated by an angle that exceeds a predetermined angle, the electric power collector 12 is automatically lowered from the overhead lines, whereas if the steering wheel 18 is rotated in reverse direction from the thus rotated state back to a normal home position, the electric power collector 12 is automatically raised from the lowered state mentioned above.
(2) On the contrary, if no overhead line is detected by the overhead line detection sensor 504, the lifting device control circuit does not react to any detection signal received from the steering wheel sensor 20 and electrically function so as to prevent upward movement of the electric power collector 502.

Further, in the present embodiment, as similar to the preceding embodiment, the manually operable up-down switch 16 may be incorporated, with such an arrangement that, when the up-down switch 16 is turned to an “UP” position for causing upward movement of the electric power collector, the aforementioned steering wheel sensor 20 and overhead line detection sensor 504 work together through the above-described controls to thereby cause appropriate vertical movement of the electric power collector in automated manner.

### Embodiment 5

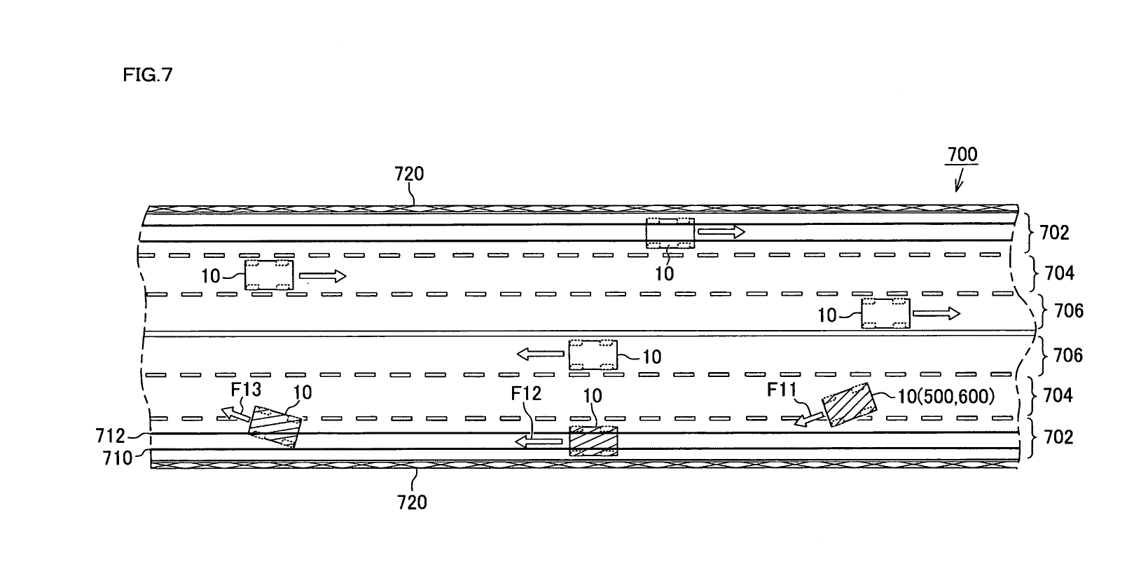

Referring now to FIG. 7, a description will be made of a 5th embodiment of the present invention will be described. As shown in the FIG. 7, according to the present embodiment, a six-lane road 700 is provided, which has an electric power supply lane 702 defined in the outermost lane of one three-lane section thereof, such that a pair of overhead lines 710 and 712 are arranged above and along that electric power supply lane 702. In this regard, those two overhead lines 710 and 712 may be arranged so as to extend over the entire length of the electric power supply lane 702, or alternatively, a plurality of such pair of overhead lines 710 and 712 may be disposed along the electric power supply lane 702 in an equidistant relation with one another, such that a predetermined distance is provided therebetween at the intervals of predetermined zones of the road. In the latter case, for example, it may be so arranged that one zone having no overhead line and another zone having such pair of overhead lines 710 and 712 are alternated with each other in and along the road.

A description will be made as to how the above-described arrangement of the present embodiment functions in effect. As illustrated, the vehicles 10 (or the vehicle 500 or 600) travel on the road, wherein each of the vehicles is normally electrically propelled by operation of the drive mechanism 26 energized by electric power stored in the battery 24. Hence, it is to be understood that the vehicle is basically similar to an ordinary electric automobile. In this context, let us assume that one or some of the vehicles 10 moving on either the lane 704 or the lane 706 require charging the battery 24 provided therein. In that case, the vehicle(s) 10 will have to change the lane towards the electric power supply lane 702, as indicated by the arrow F11. Upon the vehicle having reached that lane 702, the electric power collector 12 (or 502) is moved upwardly through the operations elaborated previously and brought to contact with the two overhead lines 710 and 712. As a result thereof, an electric power is supplied from the electric power collector 12 to the vehicle, and then, the power supply/distribution control unit 28 is activated so as to charge the battery 24 (see the FIG. 2(A)). Under such state, the vehicle 10 travels on and along the lane in the direction of the arrow F12. After completion of charging the battery 24, suppose that the vehicle 10 is moved away from the electric power supply lane 702 towards either the lane 704 or the lane 706, as indicated by the arrow F13. Then, the electric power collector 12 is lowered in the manner described earlier. Thereafter, the vehicle(s) 10 will be electrically driven as an ordinary electric vehicle and continue to travel on the road.

As described above, according to the present embodiment, it is to be appreciated that the vehicle is normally propelled electrically by electric power charged in the battery 24 for travel on the road, and, when the electric power is consumed and the battery requires charging, the vehicle may go into the electric power supply lane 702, so that the battery 24 can be charged there, while the vehicle is in the state of running on and long that electric power supply lane. As compared with the preceding embodiments, it is to be seen that the present embodiment is advantageous in providing a much simplified arrangement of the overhead lines.

It should be understood that the present invention is not limited to the above-described embodiments, but, various modifications may be applied thereto without departing from the gist and claimed scopes of the invention. For example, the following aspects are compassed by the present invention.
(1) The overhead lines may not necessarily be arranged in all kinds of roads, but may be disposed only in a road(s) having a relatively great width. Further, in the case of the road having a plurality of lanes defined therein, the overhead lines may be disposed only in one of those lanes, as shown in FIG. 7.
(2) In the embodiments described earlier, the brush-like ground element is provided on the side of vehicle that faces the road. But, such brush-like ground element may be provided on the other side of vehicle that faces the overhead lines. In this context, an electric power to be supplied through the overhead lines may be either of alternate-current and direct-current electric power.
(3) The electric power collector and lifting device may be provided by using any corresponding conventional power collector and lifting device. In the present invention, those devices are used in the vehicle light in weight relative to the bus and trains, and therefore, when a small number of passengers are in the vehicle, the amount of electric power to be consumed in the vehicle is quite small in comparison with the bus and trains. Hence, the electric power collector and lifting device may sufficiently be of a small and simplified construction requiring a small capacity of electric power, which in turn allows for use of a small-capacity battery. This also results in decrease of voltage in the overhead lines, so that safety aspects can be improved in the present invention.
(4) According to the above-described embodiments, an electric power supplied from the electric power collector to the vehicle is to be supplied to the drive mechanism. This is not limitative, but, the electric power may be supplied from the electric power collector to the drive mechanism, or supplied from the battery to the drive mechanism, depending on the situation and requirements.
(5) The above-described embodiments may be combined together in a desired manner. For instance, the ringed electric power collector 502 in the Embodiment 3 may be applied to the Embodiment 1.
(6) In the Embodiment 5 shown in FIG. 7, the two overhead lines 710 and 712 are arranged above and along the electric power supply lane 702. Instead thereof, either overhead line(s) or electric power supply rail(s) may be arranged on and along a fence 720 disposed along one or two lateral end portions of the road 700, or may be arranged on and along the surface of the electric power supply lane 702 of that road. And also, the electric power collector of vehicle may be in a sliding contact with one of the thus-arranged overhead line(s) and electric power supply rail(s). In that way, the battery 24 may be charged during travel of the vehicle on the road.

### INDUSTRIAL APPLICABILITY

In accordance with the present invention, a battery of vehicle can be charged, while the vehicle is in the state of traveling on a road that has overhead line(s) for electric power supply, and therefore, the vehicle can continue running on even a road having no such overhead line(s). In particular, the present invention is quite suited for traffic system in local areas around a large city.

1. A vehicle to be occupied and driven by person(s) for travel on road, comprising:
an electric power collector adapted for receiving and collecting an electric power supplied from overhead line(s) arranged above said road;
a lifting device operable for vertical movement with respect to said overhead line(s) to which said electric power collector is made accessible;
a battery capable of storing said electric power therein;
a drive mechanism for causing movement of said vehicle;
a power supply/distribution control unit which, responsive to said electric power being supplied from said electric power collector, operates to cause the electric power to supply to one or both of said battery and said drive mechanism, or alternatively operates to cause electric power stored in said battery to supply to said drive mechanism, responsive to no electric power supplied from the electric power collector; and
a steering wheel sensor for detecting movement of a steering wheel of the vehicle, said steering wheel sensor being workable such that, upon detecting rotation of said steering wheel by an angle exceeding a predetermined angle, the steering wheel sensor outputs one signal for prohibiting contact of said electric power collector with said overhead line(s) and sends said one signal to said lifting device, and that, upon said steering wheel having been rotated reversely from the thus-rotated state back to a normal home position, the steering wheel sensor outputs another signal calling for contact of said electric power collector with said overhead line(s) and sends said another signal to said lifting device.

2. A vehicle to be occupied and driven by person(s) for travel on road, comprising:
an electric power collector adapted for receiving and collecting an electric power supplied from overhead line(s) arranged at said road;
a lifting device operable for vertical movement with respect to the overhead line(s) to which said electric power collector is made accessible;
a battery capable of storing said electric power therein;
a drive mechanism for causing movement of said vehicle;
a power supply/distribution control unit which, responsive to the electric power being supplied from said electric power collector, operates to cause said electric power to supply to one or both of said battery and said drive mechanism, or alternatively operates to cause electric power stored in said battery to supply to said drive mechanism, responsive to no electric power supplied from the electric power collector; and
an overhead line detection sensor for detecting presence and absence of said overhead line(s), said overhead line detection sensor being workable such that, upon detecting said overhead line(s), the overhead line detection sensor outputs one signal for calling for contact of said electric power collector with said overhead line(s) and sends said one signal to said lifting device, and that, upon detecting no overhead line, the overhead line detection sensor outputs another signal for prohibiting contact of said electric power collector with said overhead line(s) and sends said another signal to said lifting device.

3. A vehicle to be occupied and driven by person(s) for travel on road, comprising:
an electric power collector adapted for receiving and collecting an electric power supplied from overhead line(s) arranged at said road;
a lifting device operable for vertical movement with respect to said overhead line(s) to which said electric power collector is accessible;
a battery capable of storing said electric power therein;
a drive mechanism for causing movement of said vehicle;
a power supply/distribution control unit which, responsive to said electric power being supplied from said electric power collector, operates to cause said electric power to supply to one or both of said battery and said drive mechanism, or alternatively operates to cause the electric power stored in said battery to supply to said drive mechanism, responsive to no electric power supplied from the electric power collector;
a steering wheel sensor for detecting movement of a steering wheel of the vehicle;
an overhead line detection sensor for detecting presence and absence of said overhead line(s); and
a lifting control means workable in such a manner that, while said overhead line(s) is/are being detected by said overhead line detection sensor, if said steering wheel sensor detects rotation of said steering wheel by an angle exceeding a predetermined angle, the lifting control means outputs one signal for prohibiting contact of said electric power collector with said overhead line(s) and sends said one signal to said lifting device, and that, upon said steering wheel having been rotated reversely from the thus-rotated state back to a normal home position, the lifting control means outputs another signal calling for contact of said electric power collector with said overhead line(s) and sends said another signal to said lifting device, wherein said lifting control means is also workable such that, if no overhead line is detected by the overhead line detection sensor, the lifting control means positively works to prohibit contact of said electric power collector with said overhead line(s), irrespective of any detection result received from said steering wheel sensor thereto.

4. The vehicle as described in claim 1, comprising:
a charging plug for allowing said battery to be charged while said vehicle is parked; and
a rectifier for rectifying an electric power supplied from said charging plug,
wherein said vehicle is further characterized in that, upon the electric power being supplied to said charging plug, said power supply/distribution control unit works to cause electric power outputted from said rectifier to supply to said battery, thereby charging the battery.

5. The vehicle as described in 1, wherein said electric power collector includes a ringed portion defined therein, said ringed portion being adapted for contact with said overhead line(s).

6. A traffic system for use with the vehicle described in claim 1, wherein a road is provided, said road having a plurality of lanes defined therein, and said overhead line(s) is/are arranged in each of said plurality of lanes.

7. A traffic system for use with the vehicle described in claim 1, wherein a road is provided, said road having a plurality of lanes defined therein, and said overhead line(s) is/are arranged in at least one of said plurality of lanes.

8. A traffic system for use with the vehicle described in claim 1, wherein a road is provided, said road having a plurality of lanes defined therein, and at least one of said plurality of lanes includes a means for allowing said battery to be charged, while said vehicle is traveling on said at least one of the plurality of lanes.

9. The traffic system as described in claim 6, wherein an obstacle element is provided, which prevents entry of people into the road having overhead line(s) arranged therein, such that said obstacle element is disposed along a boundary between the road and other area.
